(19) United States
(12) Patent Application Publication
(10) Pub. No.: US 2003/0176517 A1
(43) Pub. Date: Sep. 18, 2003

(54) Shaped body made from wood particles and a PU bonding agent, use and production thereof

(76) Inventors: Hans R. Striewski, Fockbek (DE); Lothar Thiele, Langenfeld (DE); Peter Kohlstadt, Velbert (DE)

Correspondence Address: Michael E. Carmen, Esq., DILWORTH & BARRESE, LLP, 333 Earle Ovington Blvd., Uniondale, NY, 11553, US

(21) Appl. No.: 10/413,807

(22) Filed: Apr. 15, 2003

Related U.S. Application Data
(63) Continuation of application No. 09/581,778, filed on Aug. 18, 2000.
Application No. 09/581,778 is a 371 of international application No. PCT/EP98/08048, filed on Dec. 10, 1998.

(30) Foreign Application Priority Data
Dec. 17, 1997 (DE) 197 56 154.3

(51) Int. Cl. C08J 9/00

(52) U.S. Cl. 521/82

(57) ABSTRACT

A molding prepared from a composition that includes (a) wood particles and/or cellulose-containing material; (b) at least one polyisocyanate; (c) at least one polyol and/or polyamine; and, (d) at least one carboxylic acid-containing blowing agent is provided. Processes for producing the molding are also provided.

This invention relates to a molding consisting essentially of the following components:

A) wood particles and/or cellulose-containing material (component A) and

B) porous PU binder (component B),

the ratio by weight of component B) to component A) being in the range from 0.05 to 1.0:1 and the molding being obtainable by reaction of at least one polyisocyanate with at least one polyol and at least one blowing agent in the presence of component A) under an initial pressure of at least 1 kp/cm².

One such molding is described in WO 97/03794 and also in DE 19604575.

In both cases, water is used as the blowing agent. Since the wood particles contain different amounts of water according to their type and their storage conditions, the water content of the wood particles has to be continuously monitored and corrected if reproducible results are to be obtained.

The object of the present invention was to avoid this disadvantage with a view to obtaining reproducible moldings, more particularly with high strength values.

The solution to this problem is defined in the claims and consists essentially in the use of carboxylic acid as the blowing agent.

Accordingly, the present invention relates to a molding consisting essentially of

A) wood particles and/or cellulose-containing material (component A) and

A) a porous PU binder (component B),

the ratio by weight of component B) to component A) being in the range from 0.05 to 1.0:1 and the molding being obtainable by reaction of at least one polyisocyanate with at least one polyol and/or polyamine and at least one blowing agent in the presence of component A) under an initial pressure of at least 1 kp/cm², characterized in that the blowing agent contains a carboxylic acid.

The two-component polyurethane binder used in the molding according to the invention consists essentially of a reaction product of at least one polyol or polyamine with at least one polyisocyanate, at least one carboxylic acid and optionally water additionally being used as blowing agents for pore formation. Instead of polyols or polyamines and carboxylic acids, it is also possible to use hydroxycarboxylic acids or aminocarboxylic acids which may even have a functionality of more than 1.

The polyisocyanates are polyfunctional. Suitable polyfunctional isocyanates preferably contain on average 2 to at most 5, preferably up to 4 and more preferably 2 or 3 NCO groups. Examples of suitable isocyanates are phenyl isocyanate, 1,5-naphthylene diisocyanate, 4,4′-diphenyl methane diisocyanate (MDI), hydrogenated MDI (H₁₂MDI), xylylene diisocyanate (XDI), m- and p-tetramethyl xylylene diisocyanate (TMXDI), 4,4′-diphenyl dimethyl methane diisocyanate, di- and tetraalkyl diphenyl methane diisocyanate, 4,4′-dibenzyl diisbcyanate, 1,3-phenylene diisocyanate, 1,4-phenylene diisocyanate, the isomers of toluene diisocyanate (TDI), optionally in admixture, 1 -methyl-2,4-diisocyanatocyclohexane, 1,6-diisocyanato-2,2,4-trimethyl hexane, 1,6-diisocyanato-2,4,4-trimethyl hexane, 1-isocyanatomethyl-3-isocyanato-1,5,5-trimethyl cyclohexane (IPDI), chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (HDI), dicyclohexyl methane diisocyanate, cyclohexane-1,4-diisocyanate, ethylene diisocyanate, phthalic acid-bis-isocyanatoethyl ester, polyisocyanates containing reactive halogen atoms, such as 1-chloromethylphenyl-2,4diisocyanate, 1-bromomethylphenyl-2,6-diisocyanate, 3,3-bis-chloromethylether4,4′-diphenyl diisocyanate. Sulfur-containing polyisocyanates are obtained, for example, by reacting 2 moles of hexamethylene diisocyanate with 1 mole of thioglycol or dihydroxydihexyl sulfide. Other important diisocyanates are trimethyl hexamethylene diisocyanate, 1,4-diisocyanatobutane, 1,12-diisocyanatododecane and dimer fatty acid diisocyanate.

Also of interest are partly masked polyisocyanates from which self-crosslinking polyurethanes can be formed, for example dimeric toluene diisocyanate, and polyisocyanates partly or completely reacted, for example, with phenols, tertiary butanol, phthalimide, caprolactam.

In one particular embodiment, the isocyanate component contains dimer fatty acid isocyanate. Dimer fatty acid is a mixture of predominantly C₃₆ dicarboxylic acids which is prepared by thermal or catalytic dimerization of unsaturated C₁₈ monocarboxylic acids, such as oleic acid, tall oil fatty acid or linoleic acid. Dimer fatty acids are well-known to the expert and have long been commercially obtainable. The dimer fatty acid can be reacted to form dimer fatty acid isocyanates. Technical dimer fatty acid diisocyanate contains on average at least two and less than three isocyanate groups per molecule dimer fatty acid. In a preferred embodiment, more than 30% by weight, more particularly at least most and preferably all of the isocyanate component a) consists of aromatic isocyanates, such as MDI.

Aromatic isocyanates are generally preferred, as are oligomerized NCO-terminated adducts of the above-mentioned isocyanates and polyols, polyamines or aminoalcohols. Unexpectedly, however, aliphatic and cycloaliphatic isocyanates are also capable of reacting quickly and completely even at room temperature.

Partly masked polyisocyanates from which self-crosslinking polyurethanes can be formed, for example dimeric toluene diisocyanate, are of interest. Finally, prepolymers, i.e. oligomers containing several isocyanate groups, may also be used. It is known that prepolymers can be obtained by using a large excess of monomeric polyisocyanate in the presence of diols for example. lsocyanuratization products of HDI and biuretization products of HDI may also be used.

Preferred di- or polyisocyanates are the aromatic isocyanates, for example diphenyl methane diisocyanate, either in the form of the pure isomers, as an isomer mixture of the 2,4′-/4,4′-isomers or even the carbodiimide-liquified diphenyl methane diisocyanate (MDI) known commercially, for example, as Isonate 143 L and the so-called “crude MDI”, i.e. the isomer/oligomer mixture of MDI which is commercially available, for example, under the name of PAPI or Desmodur VK. So-called “quasi-prepolymers”, i.e. reaction products of MDI or toluene diisocyanate (TDI) with low molecular weight diols, for example ethylene glycol, diethylene glycol, propylene glycol, dipropylene glycol or triethylene glycol, may also be used.

Preferred polyols for the binder are liquid polyhydroxy compounds, more particularly containing two or three hydroxyl groups per polyether and/or polyester molecule such as, for example, di- and/or trifunctional polypropylene glycols with molecular weights in the range from 200 to 6000 and preferably in the range from 400 to 3000. Statistical and/or block copolymers of ethylene oxide and propylene oxide may also be used. Another group of preferred polyether polyols are the polytetramethylene glycols which are obtained, for example, by the acidic polymerization of tetrahydrofuran. The molecular weight of the polytetramethylene glycols is in the range from 200 to 6000 and preferably in the range from 40 to 4000.

Other suitable polyols are the liquid polyesters which may be prepared, for example, by condensation of di- or tricarboxylic acids such as, for example, adipic acid, sebacic acid and glutaric acid, with low molecular weight diols or triols such as, for example, ethylene glycol, propylene glycol, diethylene glycol, triethylene glycol, dipropylene glycol, butane-1,4-diol, hexane-1,6-diol, glycerol or trimethylol propane.

Another group of polyols suitable for use in accordance with the invention are the polyesters based on ε-caprolactone—also known as “polycaprolactones”.

However, polyester polyols of oleochemical origin may also be used. Oleochemical polyester polyols may be obtained, for example, by complete ring opening of epoxidized triglycerides of an at least partly olefinically unsaturated fatty-acid-containing fatty mixture with one or more alcohols containing 1 to 12 carbon atoms and subsequent partial transesterification of the triglyceride derivatives to form alkyl ester polyols containing 1 to 12 carbon atoms in the alkyl group. Other suitable polyols are polycarbonate polyols and dimer diols (Henkel KGaA) and, in particular, castor oil and castor oil derivatives. The hydroxyfunctional polybutadienes commercially obtainable, for example, under the name of “Poly-bd” may also be used as polyols for the compositions according to the invention. In one particular embodiment, the polyol component is a diol/triol mixture of polyether and polyester polyols.

In the context of the invention, a “blowing agent” is understood to be not only a blowing gas, but also a substance which is capable of producing blowing gases under the effect of heat or chemicals. In the present case, the carboxylic acids react with isocyanates in the presence of catalysts with elimination of CO₂ to form amides.

“Carboxylic acids” are understood to be acids which contain one or more, preferably up to three, carboxyl groups (—COOH) and at least 2 and preferably 5 to 400 carbon atoms. The carboxyl groups may be attached to saturated or unsaturated, linear or branched alkyl or cycloalkyl groups or to aromatic radicals. They may contain other groups, such as ether, ester, halogen, amide, amino, hydroxy and urea groups. However, carboxylic acids which may readily be incorporated as liquids at room temperature, such as native fatty acids or fatty acid mixtures, COOH-terminated polyesters, polyethers or polyamides, dimer fatty acids and trimer fatty acids are preferred. Specific examples of the carboxylic acids are acetic acid, valeric acid, caproic acid, caprylic acid, capric acid, lauric acid, myristic acid, palmitic acid, stearic acid, isostearic acid, isopalmitic acid, arachic acid, behenic acid, cerotic acid and melissic acids and the mono- or polyunsaturated acids palmitoleic acid, oleic acid, elaidic acid, petroselic acid, erucic acid, linoleic acid, linolenic acid and gadoleic acid. Other suitable carboxylic acids are adipic acid, sebacic acid, isophthalic acid, terephthalic acid, trimellitic acid, phthalic acid, hexahydrophthalic acid, tetrachlorophthalic acid, oxalic acid, muconic acid, succinic acid, fumaric acid, ricinoleic acid, 12-hydroxystearic acid, citric acid, tartaric acid, dimerized or trimerized unsaturated fatty acids, optionally in admixture with monomeric unsaturated fatty acids, and optionally partial esters of these compounds. Esters of polycarboxylic acids or carboxylic acid mixtures containing both COOH and OH groups, such as esters of TMP [C₂H₅—C(CH₂OH)₃], glycerol, pentaerythritol, sorbitol, glycol and alkoxylates thereof with adipic acid, sebacic acid, citric acid, tartaric acid or grafted or partly esterified carbohydrates (sugar, starch, cellulose) and ring opening products of epoxides with polycarboxylic acids, may also be used.

Besides the aminocarboxylic acids, the “carboxylic acids” preferably include “hydroxycarboxylic acids”. By “hydroxycarboxylic acids” are meant monohydroxymonocarboxylic acids, monohydroxypolycarboxylic acids, polyhydroxymonocarboxylic acids and polyhydroxypolycarboxylic acids, including the corresponding hydroxyalkoxycarboxylic acids with 2 to 600, preferably 8 to 400 and more preferably 14 to 120 carbon atoms, which contain from 1 to 9 and preferably from 2 to 3 hydroxyl groups or carboxyl groups at an H—C radical, more particularly at an aliphatic radical. The polyhydroxymonocarboxylic acids and the polyhydroxypolycarboxylic acids, including the corresponding hydroxyalkoxycarboxylic acids, are combined to form the polyhydroxyfatty acids. The dihydroxyfatty acids preferably used and their production are described in DE-OS 33 18 596 and in EP 237 959 to which reference is expressly made.

The polyhydroxyfatty acids used in accordance with the invention are preferably derived from naturally occurring fatty acids. Accordingly, they generally contain an even number of carbon atoms in the main chain and are not branched. Those with a chain length of 8 to 100 carbon atoms and more particularly 14 to 22 carbon atoms are particularly suitable. For industrial applications, natural fatty acids are mostly used in the form of technical mixtures. These mixtures preferably contain one part of oleic acid. In addition, they may contain other saturated, monounsaturated and polyunsaturated fatty acids. In principle, mixtures differing in their chain length, which may also contain saturated components or polyhydroxyalkoxycarboxylic acids with double bonds, may also be used in the production of the polyhydroxyfatty acids or polyhydroxyalkoxyfatty acids suitable for use in accordance with the invention. Accordingly, not only the pure polyhydroxyfatty acids, but also mixed products obtained from animal fats or vegetable oils, which after working up (ester cleavage, purification steps), contain more than 40% and preferably more than 60% of mono-unsaturated fatty acids, are suitable here. Examples of such mixed products are commercially obtainable natural raw materials such as, for example, bovine tallow with a chain distribution of 67% oleic acid, 2% stearic acid, 1% heptadecanoic acid, 10% saturated C₁₂₋₁₆ acids, 12% linoleic acid and 2% saturated acids containing more than 18 carbon atoms or, for example, the oil of new sunflowers (NSf) with a composition of ca. 80% oleic acid, 5% stearic acid, 8% linoleic acid and ca. 7% palmitic acid. These products may be briefly distilled after ring opening in order to reduce the unsaturated fatty acid ester components. Further purification steps (for example relatively long-lasting distillation) are also possible.

The polyhydroxyfatty acids used in accordance with the invention are preferably derived from monounsaturated fatty acids, for example from 4,5-tetradecenoic acid, 9,10-tetradecenoic acid, 9,10-pentadecenoic acid, 9,10-hexadecenoic acid, 9,10-heptadecenoic acid, 6,7-octadecenoic acid, 9,10-octadecenoic acid, 11,12-octadecenoic acid, 11,12-eicosenoic acid, 11,12-docosenoic acid, 13,14-docosenoic acid, 15,16-tetracosenoic acid and 9,10-ximenic acid. Of these, oleic acid (9,10-octadecenoic acid) is preferred. Both cis and trans isomers of all the fatty acids mentioned are suitable.

Also suitable are polyhydroxyfatty acids derived from less commonly occurring unsaturated fatty acids, such as decyl-12-enoic acid, stillingic acid, dodecyl-9-enoic acid, ricinoleic acid, petroselic acid, vaccenic acid, elaeostearic acid, punicic acid, licanic acid, parinaric acid, gadoleic acid, arachidonic acid, 5-eicosenoic acid, 5-docosenoic acid, cetoleic acid, 5,13-docosadienoic acid and/or selacholeic acid.

Polyhydroxyfatty acids which have been obtained from isomerization products of natural unsaturated fatty acids are also suitable. The polyhydroxyfatty acids thus produced differ only in the position of the hydroxy or hydroxyalkoxy groups in the molecule. They are generally present as mixtures. Although naturally occurring fatty acids as natural raw materials are preferred as a starting component for the purposes of the present invention, this does not mean that synthetically produced carboxylic acids with corresponding numbers of carbon atoms are not suitable.

A hydroxyalkoxy group of the polyhydroxyfatty acids is derived from the polyol which was used for ring opening of the epoxidized fatty acid derivative. Polyhydroxyfatty acids of which the hydroxyalkoxy group is preferably derived from primary dihydric alcohols containing up to 24 carbon atoms and more particularly up to 12 carbon atoms are preferred. Suitable diols are propane diol, butane diol, pentane diol and hexane diol, dodecane diol, preferably ethane-1,2-diol, butane-1,4-diol, hexane-1,6-diol, polypropylene glycol, polybutane diol and/or polyethylene glycol with a degree of polymerization of 2 to 40. Polypropylene glycol and/or polytetrahydrofuran diol and copolymerization products thereof are also particularly suitable diol compounds, particularly when these compounds have a degree of polymerization of about 2 to 20 units. However, triols or even higher alcohols, for example glycerol and trimethylol propane and adducts thereof with ethylene oxide and/or propylene oxide with molecular weights of up 1500, may also be used for the ring opening. In their case, polyhydroxyfatty acids containing more than two hydroxyl groups per molecule are obtained.

Instead of a polyol as the hydroxyl-containing compound, a hydroxy-carboxylic acid, for example citric acid, ricinoleic acid, 12-hydroxystearic acid, lactic acid, may also be used for ring opening. In this case, ester groups are formed instead of ether groups. In addition, amines, hydroxyl-containing amines and aminocarboxylic acids may also be used for ring opening.

However, dihydroxyfatty acids produced in particular from epoxidized unsaturated fatty acids and diols are preferred. They are liquid at room temperature and may readily be mixed with the other reactants. Dihydroxyfatty acids in the context of the present invention are understood to be both the ring opening products of epoxidized unsaturated fatty acids with water and the corresponding ring opening products with diols and crosslinking products thereof with other epoxide molecules. The ring opening products with diols may also be referred to somewhat more accurately as dihydroxyalkoxyfafty acids. The hydroxy, groups or the hydroxyalkyl group are/is preferably separated from the carboxy group by at least 1, preferably at least 3 and more preferably at least 6 CH₂ units. Preferred dihydroxyfatty acids are 9,10-dihydroxypalmitic acid, 9,10-dihydroxystearic acid and 13,14-dihydroxybehenic acid and 10,9- and 14,13-isomers thereof.

Polyunsaturated fatty acids, for example linoleic acid, linolenic acid and ricinic acid, are also suitable. A specific example of an aromatic carboxylic acid is cinnamic acid. Carboxylic acids obtainable from fats are preferred.

If the elimination of CO₂ is intended to start at temperatures as low as room temperature, it is advisable to use aminosubstituted pyridines and/or N-substituted imidazoles as catalysts. 1-Methyl imidazole, 2-methyl-1-vinyl imidazole, 1-allyl imidazole, 1-phenyl imidazole, 1,2,4,5-tetramethyl imidazole, 1-(3-aminopropyl)-imidazole, pyrimidazole, 4-dimethylaminopyridine, 4-pyrrolidinopyridine, 4-morpholinopyridine, 4-methyl pyridine and N-dodecyl-2-methyl imidazole are particularly suitable.

The above-mentioned starting materials for the PU binder, i.e. polyisocyanate, polyol, polyamides, carboxylic acids and compounds containing at least one hydroxyl, amine or carboxyl group and also catalysts are used in the following quantities: 0.1 to 1 and preferably 0.1 to 0.8 equivalents of a mixture of carboxylic acid and alcohol (ratio of alcohol to acid 20:1 to 1:20) and 0.0001 to 0.5 and preferably 0.001 to 0.1 equivalents of amine catalyst are used to one equivalent of isocyanate. Where no alcohol or polyamine is involved in the reaction, i.e. where the isocyanates are reacted with the carboxylic acids, the following rule applies: 0.1 to 4 and preferably 0.8 to 1.4 equivalents of carboxylic acid and 0.0001 to 0.5 and preferably 0.01 to 0.1 equivalents of tertiary amine catalyst are used to 1 equivalent of isocyanate. If, therefore, polycarboxylic acids or hydroxycarboxylic or aminocarboxylic acids are used, there is no need at all to add polyols.

If the polyfunctional isocyanates are to be predominantly reacted with hydroxycarboxylic acids, the amines should preferably be used in a concentration of 0.05 to 15% by weight and more preferably in a concentration of 0.5 to 10% by weight, based on the sum of hydroxycarboxylic acid and isocyanate.

Besides the pyridine and imidazole derivatives mentioned above, other catalysts, above all organometallic compounds, such as tin(II) salts of carboxylic acids, strong bases, such as alkali metal hydroxides, alcoholates and phenolates, for example di-n-octyl tin mercaptide, dibutyl tin maleate, diacetate, dilaurate, dichloride, bis-dodecyl mercaptide, tin(II) acetate, ethyl hexoate and diethyl hexoate and lead phenyl ethyl dithiocarbamate, may be added. The organometallic catalysts may also be used on their own if certain carboxylic acids, i.e. hydroxycarboxylic and aminocarboxylic acids, are used. DABCO, TMR-2 etc. (Air Products), which are quaternary ammonium salts dissolved in ethyl glycol, are mentioned as trimerization catalysts.

Aliphatic tertiary amines, more particularly with a cyclic structure, are also suitable. Among the tertiary amines, those which additionally contain isocyanate-reactive groups, more particularly hydroxyl and/or amino groups, are also suitable. Specific examples of such tertiary amines are dimethyl monoethanolamine, diethyl monoethanolamine, methyl ethyl monoethanolamine, triethanolamine, trimethanolamine, tripropanolamine, tributanolamine, trihexanolamine, tripentanolamine, tricyclohexanolamine, diethanol methyl amine, diethanol ethyl amine, diethanol propyl amine, diethanol butyl amine, diethanol pentyl amine, diethanol hexyl amine, diethanol cyclohexyl amine, diethanol phenyl amine and ethoxylation and propoxylation products thereof, diazabicyclooctane (babco), triethyl amine, dimethyl benzyl amine (Desmorapid DB, BAYER AG), bis-dimethylaminoethyl ether (Catalyst A 1, UCC), tetramethyl guanidine, bis-dimethylaminomethylphenol, 2,2′-dimorpholinodiethyl ether, 2-(2-dimethylaminoethoxy)-ethanol, 2-dimethylaminoethyl-3-dimethylaminopropyl ether, bis-(2-dimethylaminoethyl)-ether, N.N-dimethyl piperazine, N-(2-hydroxyethoxyethyl)-2-azanorbornane, Texacat DP-914 (Texaco Chemical), N,N,N,N-tetramethylbutane-1,3-diamine, N,N,N,N-tetramethylpropane-1,3-diamine and N,N,N,N-tetramethylhexane-1,6-diamine.

The catalysts may also be present in oligomerized or polymerized form, for example as N-methylated polyethylene imine.

If water is used as additional blowing agent or chain-extending agent, it can be useful to add an aliphatic tertiary amine as catalyst. In this case, the water is generally used in a quantity of 0.1 to 15% by weight and, more particularly, 0.3 to 5% by weight, based on the polyurethane.

Besides the amide group from the carboxylic acid/isocyanate reaction, the PU binders of the molding according to the invention also contain urea groups when the isocyanates react with water. They additionally contain urethane groups when the isocyanates react with polyols, with polyhydroxycarboxylic acids or with cellulose and also contain ester groups when the carboxylic acids and alcohols react.

Through the incorporation of the carboxylic acid/isocyanate reaction in the formation of the blowing gas, production of the polymer wood is largely independent of the water content of the wood particles and the cellulose-containing material. For example, a blowing reaction based mainly on the carboxylic acid reaction of the polyisocyanate can be coupled with a reaction of the hydroxyl groups of wood and cellulose and the moisture of these materials with the polyisocyanate. This reaction can be adjusted to moisture contents of the materials of 0 to 25%. However, it has also been found that constant properties of the polymer wood can be obtained by utilizing the carboxylic acid/blowing gas reaction at 0 to 25% material moisture and reactions with 5 to 30% excess isocyanate (based on the carboxylic acidlisocyanate reaction).

The quantities in which the reactants polyisocyanate, polyol and carboxylic acid are used are selected so that the polyisocyanate is used in excess. In other words, the equivalent ratio of NCO to OH groups is 5:1 and preferably between 2:1 and 1.2:1. An isocyanate excess of 5 to 50% is most particularly preferred.

The wood particles are present in the molding according to the invention in the form of wood chips and/or wood flour or as cellulose-containing material in particle sizes of at most 5 mm (thickness)×20 mm (width)×50 mm (length). A thickness range of 0.5 to 3 mm, a width range of 1 to 15 mm and a length range of 3 to 40 mm are preferred. Wood particles in the form of wood chips or wood flour with particle sizes of max. 1 mm (thickness)×max. 20 mm (width)×max. 50 mm (length) are suitable.

In one preferred embodiment of the molding according to the invention, soft woods, for example woods of the spruce, Scotch pine, silver fir, larch, birch, alder, horse chestnut, Scotch fir, aspen, willow, poplar and lime, are used as the wood starting material. However, hard woods, for example beech, hawthorn, blackthom, ash, maple, walnut apple, pear, yew or oak, may also be used. Mixtures of soft woods and hard woods may also be used.

Vegetable fibers, for example cotton, jute, flax, hemp, bast, sisal, ramie, coconut fibers, yucca fibers or manila, or chemically modified fibers, such as the viscose fibers rayon and viscose staple, cuoxam fibers, acetate fibers, and paper and cellulose yams, are used as the cellulose-containing material in the molding according to the invention. Cotton, jute, flax, hemp and viscose staple are preferred.

The moisture content of the wood particles or the cellulose-containing material in the molding according to the invention is normally between 5 and 20% by weight. If necessary, it may be increased by moistening with water or steam or reduced by drying at elevated temperature. However, the moisture content preferably corresponds to the equilibrium moisture content of the material at ambient temperature.

The moldings according to the invention may contain, for example, wires, cables, wire netting, rods or the like as inserts or reinforcing materials.

The ratio by weight of component B) to component A) is in the range from 0.05 to 1.0:1 and preferably in the range from 0.08 to 0.25:1.

The present invention also relates to a process for the production of the molding in which a) the wood particles and/or the cellulose-containing material is/are first mixed with a reactant of component B (whether the polyisocyanate, the polyol or polyamine, including the carboxylic acid, and optionally water), b) the other reactant(s), more particularly the polyisocyanate in excess, is/are added to the resulting mixture which is then homogenized, c) the homogenized mixture is introduced into a pressure-tight mold optionally coated with release agent, the polyisocyanate is reacted under an initial pressure of at least 1 kp/cm² and d) the molding is removed from the mold or freed from the mold after cooling.

The mixing and reaction steps mentioned above are preferably carried out at temperatures of 10 to 30° C. and more preferably at room temperature (18 to 25° C.). However, the reaction of the isocyanate groups is preferably carried out at 80 to 120° C. In this way, much higher strength values, particularly flexural strengths, are obtained.

The pressure treatment in the process according to the invention is carried out by reacting the reaction mixture under the natural reaction pressure. However, it is essential to apply an initial pressure, i.e. before the start of gas formation, of at least 1 kg/cm². The total pressure (natural reaction pressure+initial pressure) should in the range from at most 1 to 200 kp/cm² and preferably in the range from 30 to 180 kp/cm².

In the process according to the invention, the reaction time in the mold and hence the time required to form the molding is from 5 to 30 minutes and preferably from 10 to 20 minutes.

Pressure-tight molds are preferably used in the process according to the invention. In principle, the molding according to the invention may assume any shape. Its preferred shape is that of a cube, square, panel, strip or cylinder.

There is normally no need to provide a release agent, more particularly a Teflon® layer, between the mold and the molding. In certain cases, however, it is preferred to use Acmos release agents for PUR with the code names 39-5001, 394487, 37-3200 and 36-3182.

The molding according to the invention has the following remarkable properties:

It can be made in any form, i.e. tailor-made, for example in the form of panels, strips, cubes, squares. etc.

It is suitable as a lightweight building material because it normally has a density of 0.40 to 1.0 g/cm³, depending on the pressure, the properties of the wood or cellulose-containing materials (size and size distribution) and the quantity and composition of the polyurethane. Accordingly, it is a substitute for light and medium flat pressed sheets or medium-hard to hard wood chipboards, but without the corresponding formaldehyde problems.

It does not swell significantly in water at room temperature, i.e. its increase in thickness after 24 hours in water at 20° C. is less than 5% or 2% for thicknesses of 6 to 12 or>35 mm. It is only at an elevated water temperature of, for example, 70° C. that the increase in thickness is around 10 to 20%. This resistance to water is achieved without hydrophobicizing agents (for example paraffin). It is attributed to the penetration of the wood particles by the PU components and their reaction within the wood particles. Suitable reactants are polyisocyanates on the one hand and polyols, OH groups of the wood, (hydroxy)carboxylic acids and water and amines on the other hand.

The mechanical properties, more particularly the strengths and elasticity values, are at a high level.

In contrast to many of the wood materials and MDF boards still used today, it is formaldehyde-free and substantially non-inflammable.

The moldings are so elastic that 5 mm diameter wood screws can be screwed in without splintering.

In addition, the moldings are so dimensionally stable that screwthreads can be cut for Spax screws, i.e. screws with a broad thread.

The moldings are easy to paint.

Finally, the homogeneity of the moldings is emphasized, i.e. there is none of the otherwise usual layer formation and, in particular, there are also no inner and outer layers to be seen.

All the performance properties of the moldings are easy to reproduce by virtue of the fact that the gas forming process is independent of moisture.

By virtue of these properties, the molding according to the invention is suitable as a substitute for wood materials and plastics for numerous applications.

Finally, the present invention relates to the use of the molding described above or produced by the process described above in the form of panels, strips, cubes, squares etc. The present invention also relates to the use of this molding obtainable as described above as a semifinished product or as a lining material for humid environments or external applications, more particularly in the building industry. In addition, the molding according to the invention may be used as a packaging material, floor covering, as stairsteps or ornamental balconies. The above-mentioned uses of the molding preferably relate to the interior finishing of vehicles, more particularly motor vehicles, such as automobiles and camping vehicles, but also caravans, ships and aircraft. Alternatively, the moldings according to the invention may be used for decorative purposes outdoors or in the domestic and institutional sectors, more particularly in kitchens and bathrooms.

The invention is illustrated by the following Examples.

### EXAMPLE 1

### A) Starting Products

a) Polyol Component

| | Parts by weight |
|---|---|
| dipropylene glycol | 21.00 |
| glycerol | 7.00 |
| polypropylene glycol, Mn 400 | 56.52 |
| rapeseed oil fatty acid | 14.00 |
| Tegostab 8404 (Goldschmidt) | 1.00 |
| N-methyl imidazole | 0.40 |
| dibutyl tin dilaurate | 0.08 |

b) Isocyanate Component

| | |
|---|---|
| diphenyl methane-4,4′-diisocyanate | 140 |
| (crude product) | |

### B) Production

15 kg of 1 to 3 mm thick wood chips of spruce, beech and poplar wood with a chip length of up to 1 cm were mixed for 3 minutes with 1.08 kg of the polyol component in a Turbolent mixer. After addition of 1.52 kg of isocyanate and further mixing, the mixture was transferred to a metal mold where it was pressed for 10 minutes at 80° C. under a pressure of 1.50 kp/cm². The 18 mm thick panel produced had a density of 0.75 g/cm³ and a smooth surface and could be mechanically treated in the same way as wood, for example sawn, planed, sanded, milled and drilled. A screw-thread can be cut into the material.

c) Properties

| Properties | Test method | Dimension | Value |
|---|---|---|---|
| 1. Transverse tensile strength | DIN 52 365 | N/mm² | 2.3 |
| 2. Flexural strength | DIN 52 362 | N/mm² | 22 |
| 3. Modulus of elasticity | DIN 52 362 | N/mm² | 2100 |
| 4. Swelling in water | DIN 68 763 | | |
| Increase in thickness | a) 5 hours/70° C. | % | 13 |
| | b) 24 hours/70° C. | % | 17 |
| | c) 2 hours/100° C. | % | 17 |
| 5. Water absorption | DIN . . . | % | |
| | a) 5 hours/70° C. | % by weight | 32 |
| | b) 24 hours/70° C. | % by weight | 50 |
| | c) 2 hours/100° C. | % by weight | 52 |

1. A molding consisting essentially of
A) wood particles and/or cellulose-containing material (component A) and
B) a porous PU binder (component B),
the ratio by weight of component B) to component A) being in the range from 0.05 to 1.0:1 and the molding being obtainable by reaction of at least one polyisocyanate with at least one polyol and/or polyamine and at least one blowing agent in the presence of component A) under an initial pressure of at least 1 kp/cm²₁ characterized in that the blowing agent contains a carboxylic acid.

2. A molding as claimed in claim 1, characterized in that the wood particles are used in the form of wood chips or wood flour with particle sizes of max. 1 mm (thickness)×max. 20 mm (width)×max 50 mm (length).

3. A molding as claimed in claim 1, characterized in that vegetable fibers, such as cotton, jute, flax, hemp, or chemically modified fibers, such as viscose staple, are used as the cellulose-containing material.

4. A molding as claimed in claim 1, characterized in that the polyisocyanate is a diisocyanate or triisocyanate, more particularly diphenylmethane4,4′-diisocyanate (crude product),

5. A molding as claimed in claim 1, characterized in that the polyol is a diol/triol mixture of polyether and/or polyester polyols.

6. A molding as claimed in claim 1, characterized in that the carboxylic acids can be produced from fats.

7. A molding as claimed in at least one of the preceding claims, characterized by an equivalent ratio of alcohol OH groups to carboxylic acid groups of 20:1 to 1:20.

8. A molding as claimed in at least one of the preceding claims, characterized in that it has a density of 0.40 g/cm³ to 1.0 g/cm³.

9. A molding as claimed in at least one of the preceding claims, characterized in that, in addition to components A and B, it also contains inserts or reinforcements such as, for example, wires, cables, wire netting or rods (component C).

10. A molding as claimed in at least one of the preceding claims, characterized by its shape as a cube, square, panel, strip or cylinder.

11. A process for producing the molding claimed in at least one of the preceding claims, characterized in that
a) the wood particles and/or the cellulosecontaining material (component A) is/are first mixed with a reactant of component B,
b) the remaining constituents of component B) are added to the resulting mixture which is then homogenized,
c) the homogenized mixture is introduced into a pressure-tight mold and the polyisocyanate is reacted under an initial pressure of at least 1 kp/cm³ and
d) the molding is removed from the mold or freed from the mold.

12. A process as claimed in claim 11, characterized in that process steps (a) to (c) are carried out at temperatures of 10 to 30° C. and more particularly at room temperature (18 to 25° C.), the reaction (step (c)) preferably being carried out at 80 to 120° C.

13. A process as claimed in claim 11, characterized in that the reaction of the reaction mixture in step (c) is carried out under an initial pressure of more than 1 kp/cm² and a total pressure of at most 1 to 200 kp/cm².

14. The use of the molding claimed in at least one of claims 1 to 10 or produced by the process claimed in at least one of claims 11 to 13 as a semifinished product or a lining material for humid environments or external applications, particularly in the building industry.

15. The use of the molding claimed in claim 14 for decorative purposes outdoors or in the domestic and institutional sectors, more particularly in kitchens and bathrooms.

16. The use of the molding claimed in at least one of claims 1 to 10 or produced by the process claimed in at least one of claims 11 to 13 as a packaging material, floor covering, stairsteps or ornamental balconies.

17. The use of the molding as claimed in claim 16 for the interior finishing of vehicles, more particularly motor vehicles, such as automobiles and camping vehicles, but also caravans, ships and aircraft.
